(19) United States
(12) Patent Application Publication
(10) Pub. No.: US 2006/0210349 A1
(43) Pub. Date: Sep. 21, 2006

(54) Injectable wicking composition for marking instruments

(75) Inventors: John Lane, Beverly Hills, MI (US); James Lane, Birmingham, MI (US)

Correspondence Address: VENABLE LLP, P.O. BOX 34385, WASHINGTON, DC, 20045-9998, US

(73) Assignee: Permawick Company, Bingham, MI (US)

(21) Appl. No.: 11/361,363

(22) Filed: Feb. 24, 2006

Related U.S. Application Data
(60) Provisional application No. 60/655,415, filed on Feb. 24, 2005.

(51) Int. Cl. C09D 11/00

(52) U.S. Cl. 401/198; 106/31.27; 106/31.6; 106/31.65; 106/31.33

(57) ABSTRACT

An injectable ink composition for use in marking instruments, in which cotton linters fibers are included as a wicking component, to thereby produce a material which can be used in marking instrument reservoirs, of whatever shape; the cotton linters fibers are dispersed in the ink containing composition and are present in an amount ranging from 5 to 95 percent by weight of the injectable ink containing composition.

### CROSS REFERENCE TO RELATED APPLICATION

The applicants claim the benefit of U.S. Application No. 60/655,415 filed on Feb. 24, 2005.

### FIELD OF THE INVENTION

This invention relates to marking instruments and more particularly to an alternative medium that is used to retain ink in ink reservoirs. This medium may be used in connection with a variety of ink marking devices including marking pens, felt-tip markers, highlighters, stamp pads and ink coders (for example in meat/poultry plants to stamp expiration dates on packages). The medium comprises cellulose and/or linters provided in an omni-directional matrix that functions as both a support medium and a wicking material for the ink containing composition.

### BACKGROUND OF THE INVENTION

Marking pens, stamp pads and ink coders contain a reservoir of ink that also typically contains a medium that retains the ink. This medium material is typically a porous matrix or is comprised of parallel oriented fibers. The medium material acts as wicking material and serves to hold or retain the ink. In connection with marking pens, the medium is connected to a nib or tip that is used to transfer the ink from the instrument to a surface. The ink reservoir engages the nib or applicator and allows the ink to travel to the nib and to the tip of the pen. In most applications, the ink flows from the reservoir up the nib and to the tip by both gravity and capillary action. In the case of stamp pads and ink coders, the ink is presented for use at an applicator surface. The medium is positioned in contact with the surface of the stamp or coder to allow ink to travel to the application surface. As ink is used at the surface, new ink travels to the applicator location by capillary action. The prior art discloses various media for these applications including felt reservoirs, porous plastics, and oriented fiber medium. For example, felt inserts form a matrix or wick for the ink composition contained in the ink reservoir. Felt, which is comprised of non-woven wool fibers that are bound together using heat and moisture, may be provided in a variety of forms but is typically made in planar sheets.

Prior art materials used in reservoirs such as felts foams, synthetic sponges have a single shape and structure that is retained. By comparison the injectable composition of the invention can take the shape of any cavity. Preferably the cotton linter fibers are used alone to provide the matrix/support component of the injectable composition of the invention. However, the cotton linter fibers may be used in combination with animal, vegetable and synthetic fibers described below.

Animal fibers such as wool are complex proteins. They are resistant to most organic acids and to certain powerful mineral acids such as sulfuric acid (H2SO 4). However, protein fibers are damaged by mild alkalis (basic substances) and may be dissolved by strong alkalis such as sodium hydroxide (NaOH). They can also be damaged by chlorine-based bleaches, and undiluted liquid hypochloride bleach will dissolve wool or silk. The principal component of silk, another natural fiber material, is the protein fibroin. Silk is extruded in continuous filaments from the abdomens of various insects and spiders. It is the only natural filament that commonly reaches a length of more than 1000 m (more than 3300 ft). The only silk used in commercial textiles is produced from the cocoons of the silkworm. Several silk filaments can be gathered to produce textile yarn. However, silk is often produced and used in staple form to manufacture spun yarns. It is believed that silk has not been commonly used as a matrix for ink reservoirs.

The principal component of hair, wool, and fur is the protein keratin. Individual hairs may be as long as 91 cm (36 in) but are usually no more than 41 cm (16 in). Thus, fibers of hair and wool are not continuous and must be spun into yarn if they are to be woven or knitted into textile fabrics, or they must be made into felt. Any hair fiber can legally be marketed as wool or bear the common English name of the animal from which it was gathered, for example, camel's hair. The principal hair fiber used to produce textile fabrics is sheep's wool. In wild sheep, the wool is a short, soft underlayer protected by longer, coarser hair. In domesticated sheep bred for their fleece, the wool is much longer. Yams made of wool are classified as either woolen or worsted. Wool fibers less than 5 cm (less than 2 in) in length are made into fuzzy, soft woolen yarns. Longer fibers are used for the smoother and firmer worsted yarns. Naturally crimped wool fibers produce air-trapping yarns that are used for insulating materials. It is believed that these fiber materials are not commonly used for ink reservoirs.

Vegetable fibers are predominantly cellulose. Vegetable fibers, unlike the protein of animal fibers, resist alkalis. Vegetable fibers also resist most organic acids but are destroyed by strong mineral acids. There are four major types of vegetable fibers used to make textiles: (1) seed fibers, which are the soft hairs that surround the seeds of certain plants; (2) bast fibers, the tough fibers that grow between the bark and stem of many dicotyledonous plants; (3) vascular fibers, the tough fibers found in the leaves and stems of monocotyledons; and (4) grass-stem fibers. Once again, it is believed that vegetable fibers have not been commonly used as a matrix for ink reservoirs.

Two seed fibers, cotton and kapok are commercially used. Cotton fiber is the only one that is useful for the manufacture of textiles. Different species of cotton plants produce fibers of different lengths. Long-staple fibers are spun into fine, strong yarns, which are then woven into better-quality fabrics. Short-staple fibers produce coarser yarns for durable fabrics. Cotton yarns can be dyed (see Dyeing) and printed easily, so that they are useful for producing woven fabrics with a multitude of colors and designs.

Kapok cannot be spun but is used as upholstery stuffing. Because it is hollow, kapok is buoyant. It was once used in flotation devices such as life preservers, but it has largely been replaced by other materials. A wide variety of bast fibers are used in applications ranging from fine woven textiles to cordage. Linen cloth is made from flax. Coarser textiles and rope are produced from hemp, jute, ramie, and sunn.

Vascular fibers are typically used for making cordage. They include agave (sisal), henequen, manila hemp, and yucca. The vascular fibers of pineapple have been used in the production of textiles. Entire stems of some grasses and straws, such as esparto, are woven as fibers for hats and matting.

The papermaking industry also uses vegetable fibers extensively. Cotton and flax form the basis for fine rag papers. Grasses, hemp, jute, and manila are often used in wrapping papers and other coarse papers. Newsprint and craft papers are produced from wood fiber after appropriate chemical treatment.

Synthetic fibers derived from natural cellulose are known as rayons. In a typical rayon-making process, natural cellulose made from wood pulp is treated with chemicals to form a thick liquid. This liquid is then extruded as filaments into a weak acid bath that converts the filaments back into pure cellulose. Rayons are not, therefore, completely synthetic but are actually regenerated fibers. Acetates and triacetates, which are true synthetic fibers, were developed shortly after rayon. They are derived from cellulose acetate (see Esters) in a process similar to that used for making rayon.

Most synthetic fibers are now derived from organic polymers, materials consisting of large organic molecules. Most of them are thermoplastic—that is, they are softened by heat. The first commercially successful organic synthetic fiber, nylon (polyamide), dates from 1938. Since then many other fibers, including acrylic (polyacrylonitrile), aramid (aromatic polyamide), olefins (polyethylene and polypropylene), polyester, and spandex (polyurethane), have been developed. In a typical fiber-spinning process, a molten polymer or polymer solution is extruded through tiny holes in a spinneret into an environment that causes the filaments to solidify. The fiber's properties depend on the base polymer, the spinning process, and the post-spinning treatment of the fiber, which can include drawing, annealing, applying a finish, and coating. Fiber properties such as weight, abrasion resistance, heat resistance, chemical resistance, moisture resistance, strength, stiffness, elasticity, and ease of dyeing and coloring can be optimized by such treatments.

Conventional marking pens are typically formed in the shape of a barrel or cylinder that can be easily grasped by the hand of a user. When a marking instrument is unconventionally shaped, or a stamp pad or ink coder is being produced the configuration of the reservoir may be other than a cylindrical or barrel-shaped configuration.

### SUMMARY OF THE INVENTION

The invention relates to the injectable ink containing compositions as contents of the reservoir of such marking instruments. The invention relates to an ink-containing composition comprising colorant (e.g. ink pigment or dye) and a liquid vehicle for the colorant, in combination with a support or matrix or wicking material for the ink containing material. The support material is comprised of an omni-directional fiber matrix made from cellulose fibers or linters. The ink containing composition may in turn contain various adjuvants, such as surfactants; however, the identity of the ink composition and its components is not per se critical. These ink containing compositions of the invention are liquid dispersions which can be injected into the reservoir. Accordingly, the present invention is directed to a material that will easily conform to any shape of the ink reservoir.

### BRIEF DESCRIPTION OF THE DRAWINGS

FIG. 1 is a side sectional view of a pen containing the ink and fiber composition according to the invention.

FIG. 2 is a cross section of the pen depicted in claim 1.

FIG. 3 is a sectional view in elevation of an ink stamper device containing the ink and fiber composition according to the invention.

### DETAILED DESCRIPTION

In a preferred embodiment, the wicking material which provides the basis for the present invention is derived from cotton linters. In accordance with the invention, the terms ‘support’ or ‘matrix’ component are used interchangeably herein with the phrase ‘wicking’ material. The wicking material comprises 5-95% by weight of the injectable composition, and usually comprises 20-80% by weight of the injectable composition of the invention. The long hairs on cotton seeds are referred to in the art as line fibers, or staple cotton. It is these fibers which are spun into textiles. In addition to the lint fibers, cotton seeds also contain short fibers which are not suitable for spinning because of their length; these short fibers are known as linters. In commercially available quantities, substantially all of these linters are 5 millimeters in length or less with a very small percentage (in the order of 5% or less) between 5-12 millimeters in length. These are described in U.S. Pat. No. 3,466,244, which is incorporated in its entirety by reference herein.

It is generally the practice of the cotton industry to gin the cotton seed to remove the staple cotton. The linters are thereafter removed from the seed prior to the extraction of cottonseed oil. The raw linters are then digested in a strong caustic solution; the digested linters thereafter undergo a series of bleaching steps, are washed and are finally formed into sheets in a paper machine or loose pulp in bundles. Such procedures for making sheets and bundles are well-known to the art; reference is made to “Hercules® Chemical Cotton,” published in 1959 by the Hercules Powder Company, for a more detailed description of the linters refining process.

The fibers which form the wicking material of the present invention are formed by comminuting these sheets to obtain, as intact as possible, the fibers from which the sheets were produced. The linters fibers thus restored from the sheets inherently have lengths generally less than 10 millimeters, usually less than 5 millimeters with a very small percentage between 5-10 millimeters. At least about 90% of the linters fibers have lengths of 5 millimeters or less. In a preferred embodiment, about 96% of the fibers have lengths of 5 millimeters or less.

It has been found that the comminuted linters fibers have a great affinity for oils, not only for the purpose of holding it, but also for restraining flow of oil away from the fibers when subjected to extruding or injecting pressures. This tenacious retaining phenomenon of the bulk material is believed to be attributable to the surface adhesion of the oil to the minute linters fibers of the bulk material. The linters fibers will readily absorb four or more parts by weight of oil per one part of bulk material. The extrusion of this wicking material into bearing wells has been described in commonly assigned U.S. Pat. No. 3,226,801, granted Jan. 4, 1966, and U.S. Pat. No. 3,273,668, granted Sep. 20, 1966. In addition to oils, the linters will also retain ink compositions as described herein.

The wicking material of the present invention has increased effectiveness over conventional cellulose materials described in commonly assigned U.S. Pat. No. 2,966,459 in specific applications, discussed above. The fibers, described in U.S. Pat. No. 2,966,459, expressly incorporated by reference herein, which may form the absorbing part of the wicking material are of cellulose, being made from wood fibers and a mixture of paper-containing fibers of wood, cotton and the like. Substantially equal parts of the wood and paper are macerated to produce the fibrous material, the major amount of the material having fiber lengths of from 0.5 to 2.0 millimeters in length. The sound length of the fibers is shown in the following analysis of a sample thereof:

Length of fiber

| Millimeters: | | Percentage |
|---|---|---|
| 0.5 | ------------------------------- | 18 |
| 1.0 | ------------------------------- | 39 |
| 1.5 | ------------------------------- | 18 |
| 2.0 | ------------------------------- | 11 |
| 2.5 | ------------------------------- | 6 |
| 3.0 | ------------------------------- | 4 |
| 3.5 | ------------------------------- | 4 |

It will be seen that the greater numbers of fibers are substantially one millimeter in length and when mired with the smaller and larger fibers have a great affinity for liquids, not only for holding the liquids but for retaining it against flow therefrom. Wicking materials having longer fibers alone or combined with asbestos, talc and the like, generally lack this retaining property when the material is saturated, the liquid collecting at the bottom of a mixture from which it will drip. Especially is this true if the material is heated to 180° F. for example. For example, the present material when saturated with oil not only holds the oil but retains the oil against flow in the bottom of a mixture even in the presence of the 180° temperature. This tenacious retaining property of the bulk material is attributed to the surface adhesion of the oil on the minute cellulose particles of the bulk material. Likewise, the fibers will also retain inks. These fibers can be used alone in accordance with the invention or together with either or both synthetic fibers and other naturally occurring fibers. While it was known to use these fibers in connection with oils, the present invention uses the material with inks.

The cotton linters, used in the invention, substitute for the medium that may be conventionally used in marking instruments; as such it behaves as wicking material. Pens that are commonly referred to as “felt tip pens” are also called porous-pointed pens or soft tip pens. These pens have a relatively soft writing tip or nib that is typically made of an absorbent plastic. Soft-tip pens use fluid, which is typically brilliantly colored inks. The reservoir in most conventional soft-tip pens consists of a synthetic material made up of many fibers oriented in parallel configuration. This type of reservoir is called a capillary reservoir and in general holds ink in a similar way that a sponge holds water. During writing, the absorbent tip of a soft-tip pen continually draws ink from the reservoir onto the paper. In contrast the fibers in the present invention are omni-directional.

Because the cotton linter fibers are dispersed in the ink composition, which is liquid, the ink and medium composition may be injectable into a reservoir. In preferred embodiments, the amount of cotton linter fibers in the dispersion ranges from 5-95%, usually 10 to 90% by weight. The exact nature of the ink composition and the identity of the components of the ink composition, i.e., the colorant and/or the vehicle, is not per se critical. It is the combination of an ink with the cotton linters fibers, as a wicking material, to form an injectable ink containing composition which is an object of the invention. The support or matrix material of the ink containing materials acts as a wick.

The colorant used in the present invention includes, for example, organic and inorganic pigments and organic and inorganic dyes, including water soluble dyes and water insoluble dyes and pigments, which may be organic or inorganic including, for example, inorganic and organic pigments, titanium oxide and pseudo pigments obtained by coloring resin emulsions with dyes, which have so far been used for a water based ink composition. The following references to pigments and dyes is by way of illustration and not by way of limitation.

Examples of inorganic pigments include carbon black metal powder, titanium black, zinc oxide, red iron oxide, chromium oxide, mica titan, black iron oxide, cobalt blue, yellow iron oxide, viridian, zinc sulfide, lithopone, cadmium yellow, vermilion, cadmium red, chrome yellow, molybdate orange, zinc chromate, strontium chromate, white carbon, clay, talc, ultramarine, precipitated barium sulfate, baryte powder, calcium carbonate, white lead, Prussian blue, manganese violet, aluminum powder and bronze powder, C. I. Pigment Blue 1, C. I. Pigment Blue 15, C. I. Pigment Blue 17, C. I. Pigment Blue 27, C. I. Pigment Red 5, C. I. Pigment Red 22, C. I. Pigment Red 38, C. I. Pigment Red 48, C. I. Pigment Red 49, C. I. Pigment Red 53, C. I. Pigment Red 57, C. I. Pigment Red 81, C. I. Pigment Red 104, C. I. Pigment Red 146, C. I. Pigment Red 245, C. I. Pigment Yellow 1, C. I. Pigment Yellow 3, C. I. Pigment Yellow 12, C. I. Pigment Yellow 13, C. I. Pigment Yellow 14, C. I. Pigment Yellow 17, C. I. Pigment Yellow 34, C. I. Pigment Yellow 55, C. I. Pigment Yellow 74, C. I. Pigment Yellow 83, C. I. Pigment Yellow 95, C. I. Pigment. Yellow 166, C. I. Pigment Yellow 167, C. I. Pigment Orange 5, C. I. Pigment Orange 13, C. I. Pigment Orange 16, C. I. Pigment Violet 1, C. I. Pigment Violet 3, C. I. Pigment Violet 19, C. I. Pigment Violet 23, C. I. Pigment Violet 50, and C. I. Pigment Green 7. The organic pigments include, for example, azo lakes, insoluble azo pigments, chelate azo pigments, phthalocyanine pigments, perylene and perinone pigments, anthraquinone pigments, quinacridone pigments, dye lakes, nitro pigments and nitroso pigments.

The pseudo pigments obtained by coloring resin emulsions with dyes include, for example, those obtained by coloring resins comprising copolymers of acrylonitrile, styrene and methyl methacrylate with dyes.

Any of direct dyes, acid dyes, food colors and basic dyes can be used for the water-soluble dyes. Dyes which may be used with the cellulose fibers are enumerated below, by way of illustration:

Direct dyes include, for example, C. I. Direct Black 17, C. I. Direct Black 19, C. I. Direct Black 22, C. I. Direct Black 32, C. I. Direct Black 38, C. I. Direct Black 51 and C. I. Direct Black 71, C. I. Direct Yellow 4, C. I. Direct Yellow 6, C. I. Direct Yellow 44 and C. I. Direct Yellow 50, C. I. Direct Red 1, C. I. Direct Red 4, C. I. Direct Red 23, C. I. Direct Red 31, C. I. Direct Red 37, C. I. Direct Red 39, C. I. Direct Red 75, C. I. Direct Red 80, C. I. Direct Red 81, C. I. Direct Red 83, C. I. Direct Red 225, C. I. Direct Red 226 and C. I. Direct Red 227, C. I. Direct Blue 1, C. I. Direct Blue 15, C. I. Direct Blue 71, C. I. Direct Blue 86, C. I. Direct Blue 106 and C. I. Direct Blue 119.

The acid dyes include, for example, C. I. Acid Black 1, C. I. Acid Black 2, C. I. Acid Black 24, C. I. Acid Black 26, C. I. Acid Black 31, C. I. Acid Black 52, C. I. Acid Black 107, C. I. Acid Black 109, C. I. Acid Black 110, C. I. Acid Black 119 and C. I. Acid Black 154, C. I. Acid Yellow 7, C. I. Acid Yellow 17, C. I. Acid Yellow 19, C. I. Acid Yellow 23, C. I. Acid Yellow 25, C. I. Acid Yellow 29, C. I. Acid Yellow 38, C. I. Acid Yellow 42, C. I. Acid Yellow 49, C. I. Acid Yellow 61, C. I. Acid Yellow 72, C. I. Acid Yellow 78, C. I. Acid Yellow 110, C. I. Acid Yellow 127, C. I. Acid Yellow 135, C. I. Acid Yellow 141 and C. I. Acid Yellow 142, C. I. Acid Red 8, C. I. Acid Red 9, C. I. Acid Red 14, C. I. Acid Red 18, C. I. Acid Red 26, C. I. Acid Red 27, C. I. Acid Red 35, C. I. Acid Red 37, C. I. Acid Red 51, C. I. Acid Red 52, C. I. Acid Red 57, C. I. Acid Red 82, C. I. Acid Red 87, C. I. Acid Red 92, C. I. Acid Red 94, C. I. Acid Red 115, C. I. Acid Red 129, C. I. Acid Red 131, C. I. Acid Red 138, C. I. Acid Red 186, C. I. Acid Red 249, C. I. Acid Red 254, C. I. Acid Red 265 and C. I. Acid Red 276, C. I. Acid Violet 15 and C. I. Acid Violet 17, C. I. Acid Blue 1, C. I. Acid Blue 7, C. I. Acid Blue 9, C. I. Acid Blue 15, C. I. Acid Blue 22, C. I. Acid Blue 23, C. I. Acid Blue 25, C. I. Acid Blue 40, C. I. Acid Blue 41, C. I. Acid Blue 43, C. I. Acid Blue 62, C. I. Acid Blue 78, C. I. Acid Blue 83, C. I. Acid Blue 90, C. I. Acid Blue 93, C. I. Acid Blue 103, C. I. Acid Blue 112, C. I. Acid Blue 113, and C. I. Acid Blue 158, C. I. Acid Green 3, C. I. Acid Green 9, C. I. Acid Green 16, C. I. Acid Green 25 and C. I. Acid Green 27.

A majority of the food colors is included in the direct dyes and the acid dyes. C. I. Food Yellow 3 is one example of an exception to that categorization.

The basic dyes include, for example, C. I. Basic Yellow 1, C. I. Basic Yellow 2 and C. I. Basic Yellow 21, C. I. Basic Orange 2, C. I. Basic Orange 14 and C. I. Basic Orange 32, C. I. Basic Red 1, C. I. Basic Red 2, C. I. Basic Red 9 and C. I. Basic Red 14, C. I. Basic Violet 1, C. I. Basic Violet 3 and C. I. Basic Violet 7, C. I. Basic Green 4, C.

I. Basic Brown 12, C. I. Basic Black 2 and ditto 8.

These colorants each may be used alone or in combination.

These colorants may be employed in amounts of 0.5 to 40% by weight, preferably 1 to 30% by weight based on the total amount of the ink composition (including colorant and liquid vehicle, exclusive of the linters fibers).

As discussed above, preferably, the ink composition and the cotton linter fibers are be formed into a dispersion which is injected into the reservoir/cartridge. However, alternatively, the fibers can be inserted into the reservoir and/or are then matted to form a felt-like cartridge. Alternatively the matrix can be heat or cold-pressed to form the matrix. In this alternative embodiment, the ink can then be added to the fiber matrix.

The identity of the vehicle, and the exact nature of the colorant, will depend on the identity of the marking instrument and the nature of its end-use application. For example, the vehicle may be an organic or inorganic solvent or solution. It may be in the form of a water-in-oil or oil-in-water emulsion. The solvents may be water, alcohols (such as ethanol, propanol), halo-hydrocarbons, ethylene glycol or propylene glycol and ether derivatives of each, as well as glycerol and derivatives thereof.

Accordingly a first advantage of using the ink and fiber matrix according to the invention is that the material can easily be injected into the reservoir area using a machine. One machine can be used to fill a variety of shaped and sized ink reservoirs. The same material can also be directly injected into various applications for increased efficiency/productivity on the production floor. Further, using an injection machine allows for a metered amount of the material to be accurately controlled. This control helps the operator to size the shot for optimum quantity control of ink and to meet the target quality.

Upon injection the composition of the invention takes the shape of the reservoir. It can easily adapt to fit and fill any size or shape cavity. Further, after it is injected, the fiber matrix holds its shape. The fibers both trap ink within the matrix or physical structure formed by the material and also directly absorb ink so there is more ink available in the same amount of space as compared to prior art applications. Thus, this invention provides a potentially much more valuable substitute for oriented fibers, previously used in, for example, fiber tip pens. By comparison, cotton linter bonds with the ink and does not give it up as easily as other mediums used in the art thus allowing a more controlled release rate. A controlled release rate protects against flooding the application with ink and promotes longer life.

The invention has been explained and illustrated by examples set forth above. However, the foregoing description is not to be considered limiting but applicant intends to embrace all equivalents and thus to be accorded the broadest scope of protection defined by the appended claims.

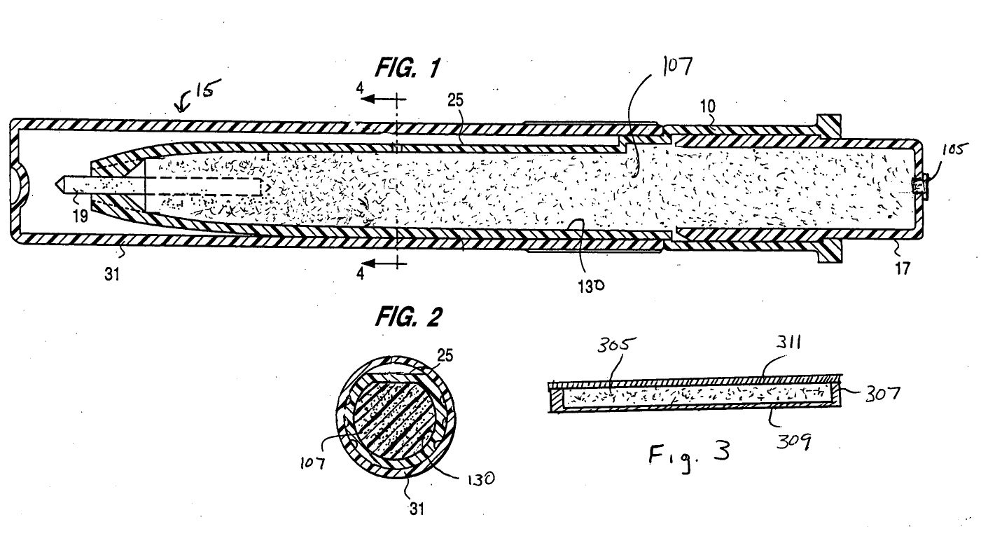

Now referring to FIG. 1, a section of a conventional barrel shaped marking pen 15 is depicted that includes a nib 19, a housing 25 defining a reservoir. The interior walls 103 of the housing 25 contain the fiber ink composition. A pen cap 31 is provide to keep the nib 19 from drying out when not in use. A bottom end cap 17 can be removed to provide access to the reservoir. In an alternative embodiment, the liquid may be injected through a channel in the end of the end cap that may be by removing plug 105. As depicted herein, the ink and fiber composition 107 is contained within the reservoir and in contact with the nib 101. FIG. 2 shows a cross section of the pen depicted in FIG. 1 along line 4-4. FIG. 3 depicts an alternative application of the ink and fiber composition wherein a composition 305 according to the invention is contained within an ink stamp pad. In this embodiment the reservoir is defined by sidewall 307, bottom 309, and at the .top of the reservoir, a porous membrane 311. The fiber and ink composition 205 is in contact with porous membrane 311 and ink contained in the composition can move by capillary action from the reservoir to the porous membrane and then through to the membrane so that it is available to a stamp.

What is claimed is:

1. An injectable ink composition for use in marking instruments, comprising
cotton linters fibers, as a wicking component; and
an ink comprising
a colorant, and
a vehicle for said colorant,
wherein the colorant is present in an amount ranging from 0.5 to about 40 weight percent of said ink;
wherein said cotton linters fibers are dispersed in the ink containing composition and are present in amount ranging from 5 to 90 percent by weight of said injectable ink composition.

2. The composition of claim 1 wherein the colorant is selected from the group consisting of organic pigment; inorganic pigment; organic dyes or inorganic dyes.

3. The composition of claim 2 wherein the vehicle is a liquid composition which comprises water, organic solvent or admixtures thereof.

4. The composition of claim 3, wherein the vehicle is a water, organic solvent or emulsions thereof. cotton linters fibers.

5. The composition of claim 1, wherein said cotton linter fibers have a maximum dimension of less than 10 mm.

6. The composition of claim 5 wherein at least 90% of the cotton linter fibers have a maximum dimension of less than 5 mm.

7. A component for a marking instrument comprising
a reservoir;
an injectable ink containing composition;
wherein the injectable ink containing composition comprises
a colorant, a liquid vehicle for said colorant, and
an amount of cotton linter fibers, as wicking material wherein said cotton linters fibers are dispersed in the ink containing composition and are present in amount ranging from 5 to 95 percent by weight of the injectable ink containing composition; and
wherein said reservoir contains said injectable ink.

8. The component of claim 7, which further includes a nib.

9. The component of claim 7, wherein said cotton linter fibers have a maximum dimension of less than 10 mm.

10. A marking instrument, comprising in combination, a nib, an applicator, a reservoir and an injectable ink containing composition, said reservoir containing said ink composition comprising cotton linters and ink.

11. The marking instrument of claim 10, wherein said cotton linter fibers have a maximum dimension of less than 10 mm.

12. The marking instrument of claim 10, wherein said cotton linter fibers have a maximum dimension of less than 10 mm.

13. A stamp pad comprising a reservoir and an applicator surface, said surface having a top and bottom side, said reservoir containing a medium comprised of cotton linters and ink, said medium in communication with said bottom side of said applicator.
